(19) United States
(12) Patent Application Publication
(10) Pub. No.: US 2025/0132562 A1
(43) Pub. Date: Apr. 24, 2025

(54) APPARATUS, METHOD, AND DEVICE FOR REGULATING CONTROL PARAMETER OF EXCITATION SYSTEM, AND MEDIUM

(71) Applicant: CSG POWER GENERATION CO., LTD. MAINT. AND TEST CO., Guangzhou (CN)

(72) Inventors: Wenbin YAN, Guangzhou (CN); Yu GONG, Guangzhou (CN); Lei ZHANG, Guangzhou (CN); Jialiang YU, Guangzhou (CN); Qiang CHEN, Guangzhou (CN); Minggang ZHU, Guangzhou (CN); Hanqiu YAN, Guangzhou (CN); Tao YU, Guangzhou (CN)

(73) Assignee: CSG POWER GENERATION CO., LTD. MAINT. AND TEST CO., Guangzhou (CN)

(21) Appl. No.: 18/707,405

(22) PCT Filed: Oct. 31, 2023
(86) PCT No.: PCT/CN2023/128517

§ 371 Date: May 3, 2024

(30) Foreign Application Priority Data
Jun. 9, 2023 (CN) 202310679648.5

(51) Int. Cl. H02J 3/00; H02M 5/04

(52) U.S. Cl. CPC H02J 3/00; H02M 5/04

(57) ABSTRACT

The present disclosure discloses an apparatus, a method, and a device for regulating a control parameter of an excitation system and a medium. The apparatus includes a parameter obtaining module and an excitation regulation module. The parameter obtaining module is connected to a first potential transformer and a second potential transformer to obtain a voltage signal of a pumped storage generator through the first potential transformer. The excitation control module is connected to an excitation system and the parameter obtaining module to obtain a current ratio of an output voltage of the pumped storage generator to a voltage of the power grid according to the voltage signal of the pumped storage generator and the voltage signal of the power grid, and obtain a target control parameter regulation strategy for the excitation system according to the current ratio.

### CROSS-REFERENCE TO RELATED APPLICATIONS

The present application is a national stage application of PCT international application No. PCT/CN2023/128517 filed on Oct. 31, 2023, which claims priority to Chinese patent application No. 2023106796485, filed on Jun. 9, 2023, the entire contents of which are incorporated herein by reference.

### TECHNICAL FIELD

The present disclosure relates to the field of pumped storage power generation, and particularly to an apparatus, a method, and a device for regulating a control parameter of an excitation system, and a medium.

### BACKGROUND

An excitation system on a pumped storage generator side is very important for the safety of the pumped storage, it not only ensures the stable operation of the pumped storage but also serves as a lever for regulating reactive power and voltage during the operation of the generator. However, the pumped storage generator is affected by factors such as large differences in water head heights, different generator speeds, significant differences in inertia and volume, etc. during the regulation process before connecting to the power grid. If the excitation system control is not effective, it may seriously affect the operation of the pumped storage generator.

### SUMMARY

According to one aspect of the present disclosure, an apparatus for regulating a control parameter of an excitation system is provided, including a parameter obtaining module and an excitation control module.

The parameter obtaining module is connected to a first potential transformer and a second potential transformer. The parameter obtaining module is configured to obtain a voltage signal of a pumped storage generator through the first potential transformer, obtain a voltage signal of a power grid through the second potential transformer, and send the voltage signal of the pumped storage generator and the voltage signal of the power grid to the excitation regulation module.

The excitation regulation module is connected to an excitation system and the parameter obtaining module. The excitation regulation module is configured to obtain a current ratio of an output voltage of the pumped storage generator to a voltage of the power grid according to the voltage signal of the pumped storage generator and the voltage signal of the power grid, obtain a target control parameter regulation strategy for the excitation system according to the current ratio of the output voltage of the pumped storage generator to the voltage of the power grid, and send the target control parameter regulation strategy to the excitation system, so that the excitation system regulates an excitation current based on the target control parameter regulation strategy.

According to another aspect of the present disclosure, a method for regulating a control parameter of an excitation system is provided. The method is applied to the above apparatus for regulating a control parameter of an excitation system, including:
the parameter obtaining module obtaining a voltage signal of a pumped storage generator through the first potential transformer, obtaining a voltage signal of a power grid through the second potential transformer, and sending the voltage signal of the pumped storage generator and the voltage signal of the power grid to the excitation regulation module;
the excitation regulation module obtaining a current ratio of an output voltage of the pumped storage generator to a voltage of the power grid according to the voltage signal of the pumped storage generator and the voltage signal of the power grid;
the excitation regulation module obtaining a target control parameter regulation strategy for the excitation system according to the current ratio of the output voltage of the pumped storage generator to the voltage of the power grid; and
the excitation regulation module sending the target control parameter regulation strategy to the excitation system, so that the excitation system regulates an excitation current based on the target control parameter regulation strategy.

According to another aspect of the present disclosure, a device for regulating a control parameter of an excitation system is provided, and the device is applied to the above apparatus for regulating a control parameter of an excitation system. The device includes a signal obtaining module, a ratio obtaining module, a target control parameter regulation strategy obtaining module, and a target control parameter regulation strategy sending module.

The signal obtaining module is configured in the parameter obtaining module to obtain a voltage signal of a pumped storage generator through the first potential transformer, obtain a voltage signal of a power grid through the second potential transformer, and send the voltage signal of the pumped storage generator and the voltage signal of the power grid to the excitation regulation module.

The ratio obtaining module is configured in the excitation regulation module to obtain a current ratio of an output voltage of the pumped storage generator to a voltage of the power grid according to the voltage signal of the pumped storage generator and the voltage signal of the power grid.

The target control parameter regulation strategy obtaining module is configured in the excitation regulation module to obtain a target control parameter regulation strategy for the excitation system according to the current ratio of the output voltage of the pumped storage generator to the voltage of the power grid.

The control parameter regulation strategy sending module is configured in the excitation regulation module to send the target control parameter regulation strategy to the excitation system, so that the excitation system regulates an excitation current based on the target control parameter regulation strategy.

According to another aspect of the present disclosure, a computer-readable storage medium is provided. The computer-readable storage medium stores computer instructions. The computer instructions, when executed by a processor, cause the processor to perform the method for regulating a control parameter of an excitation system in any embodiment of the present disclosure.

It should be understood that the content described in this part is not intended to identify key or important features of the embodiments of the present disclosure, nor is it intended to limit the scope of the present disclosure. Additional features of the present disclosure will be readily understood from the following description.

### BRIEF DESCRIPTION OF THE DRAWINGS

In order to illustrate the technical solutions in the embodiments of the present disclosure or prior art more clearly, the accompanying drawings used in the description of the embodiments or prior art will be briefly introduced below. Apparently, the accompanying drawings in the following description are only some embodiments of the present disclosure. For those of ordinary skill in the art, other drawings can also be derived from these drawings without creative effort.

FIG. 1 is a schematic diagram of a structure of an apparatus for regulating a control parameter of an excitation system according to a first embodiment of the present disclosure.

FIG. 2 is a schematic diagram of a structure of another apparatus for regulating a control parameter of an excitation system according to the first embodiment of the present disclosure.

FIG. 3 is a schematic diagram of a scenario in which a pumped storage generator is connected to a power transmission grid according to the first embodiment of the present disclosure.

FIG. 4 is a graph showing a change in a ratio of a generator output voltage to a grid voltage according to a second embodiment of the present disclosure.

FIG. 5 is a flowchart of a method for regulating a control parameter of an excitation system according to a third embodiment of the present disclosure.

FIG. 6 is a schematic diagram of a structural of a device for regulating a control parameter of an excitation system according to a fourth embodiment of the present disclosure.

### DETAILED DESCRIPTION OF THE EMBODIMENTS

To enable those skilled in the art to better understand the solutions of the present disclosure, the technical solutions in the embodiments of the present disclosure will be described clearly and completely describes below with reference to the accompanying drawings in the embodiments of the present disclosure. It can be understood that the embodiments in the following description are merely some embodiments of the present disclosure rather than all of the embodiments. All embodiments obtained by a person of ordinary skill in the art based on the embodiments of the present disclosure without creative efforts should fall within the protection scope of the present disclosure.

It should be noted that the terms “first”, “second”, etc. in the specification, claims, and the foregoing accompanying drawings of the present disclosure are used to distinguish similar objects, and are not used to indicate a specific order or sequence. It should be understood that the terms used in this manner may be interchangeable as appropriate, so that the embodiments of the present disclosure described herein can be implemented in a sequence other than those shown or described herein. In addition, the terms “include” and “comprise” and any variations thereof are intended to cover non-exclusive inclusion, for example, processes, methods, systems, products or devices that contain a series of steps or units are not necessarily limited to those steps or units that are clearly listed, but may include other steps or units that are not clearly listed or that are inherent to these processes, methods, products or devices.

At present, the Proportion Integration Differentiation (PID) control is commonly used in engineering for choosing a fixed control parameter for the excitation system of the pumped storage generator, so as to control the excitation system of the pumped storage generator using the selected fixed control parameter.

However, the excitation system on the pumped storage generator side requires different control parameters under different operating conditions to achieve a better control effect. Using a fixed control parameter may result in excessive regulation or insufficient regulation, which may lead to damage to the pumped storage equipment or failure to achieve the desired control effect.

### Embodiment 1

FIG. 1 is a schematic diagram of a structure of an apparatus for regulating a control parameter of an excitation system according to Embodiment 1 of the present disclosure. As shown in FIG. 1, an apparatus for regulating a control parameter of an excitation system includes a parameter obtaining module 200 and an excitation regulation module 100.

The parameter obtaining module 200 is connected to a first potential transformer 300 and a second potential transformer 400. The parameter obtaining module 200 is configured to obtain a voltage signal of a pumped storage generator 500 through the first potential transformer 300, obtain a voltage signal of a power grid through the second potential transformer 400, and send the voltage signal of the pumped storage generator 500 and the voltage signal of the power grid to the excitation regulation module 100. The excitation regulation module 100 is connected to an excitation system 600 and the parameter obtaining module 200. The excitation regulation module is configured to obtain a current ratio of an output voltage of the pumped storage generator to a voltage of the power grid according to the voltage signal of the pumped storage generator 500 and the voltage signal of the power grid.

Specifically, the potential transformer (PT) is a measuring device on a transmission line for transforming voltage. In embodiments of the present disclosure, the first potential transformer 300 is an electrical component on the pumped storage generator 500 side and is connected to the pumped storage generator. The second potential transformer 400 is an electrical component on the power transmission grid side. The parameter obtaining module 200 obtains a voltage signal of the pumped storage generator 500 through the first potential transformer 300 and then sends the voltage signal to the excitation regulation module 100. Meanwhile, the parameter obtaining module 200 obtains a voltage signal of the power grid through the second potential transformer 400 and sends the voltage signal to the excitation regulation module 100. After obtaining the foregoing voltage signals, the excitation regulation module 100 calculates a current ratio of an output voltage of the pumped storage generator to a voltage of the power grid at the current moment.

In an embodiment of the present disclosure, the parameter obtaining module 200 includes a first signal conditioning unit 201, a second signal conditioning unit 203, a first analog-to-digital conversion unit 202, and a second analog-to-digital conversion unit 204. The first signal conditioning unit 201 is connected to the first potential transformer 300 to remove noise from the analog voltage signal of the pumped storage generator 500. The second signal conditioning unit 203 is connected to the second potential transformer 400 to remove noise from the analog voltage signal of the power grid. The first analog-to-digital conversion unit 202 is connected to the first signal conditioning unit 201 to convert the analog voltage signal of the pumped storage generator 500 into a digital voltage signal. The second analog-to-digital conversion unit 204 is connected to the second signal conditioning unit 203 to convert the analog voltage signal of the power grid into a digital voltage signal. The excitation regulation module 100 is connected to the first analog-to-digital conversion unit 202 and the second analog-to-digital conversion unit 204 and is specifically configured to obtain a current ratio of the output voltage of the pumped storage generator to the voltage of the power grid according to the digital voltage signal of the pumped storage generator 500 and the digital voltage signal of the power grid.

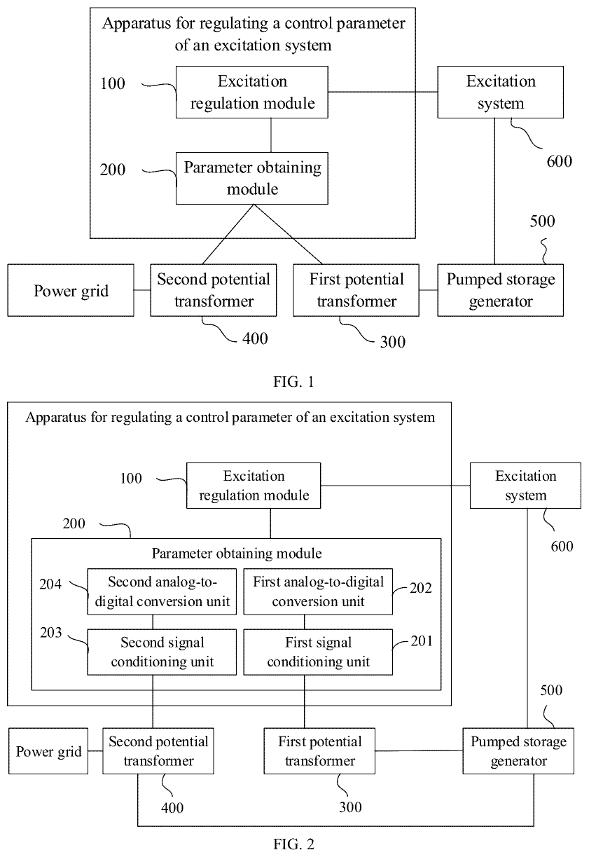

Specifically, as shown in FIG. 2, the first signal conditioning unit 201 removes noise from the analog voltage signal obtained by the first potential transformer 300. The second signal conditioning unit 203 removes noise from the analog voltage signal of the power grid obtained by the second potential transformer 400. The first analog-to-digital conversion unit 202 converts the analog voltage signal of the pumped storage generator into a digital voltage signal, and finally sends the digital voltage signal of the pumped storage generator to the excitation regulation module 100. The second analog-to-digital conversion unit 204 converts the analog voltage signal of the power grid into a digital voltage signal and sends the digital voltage signal of the power grid to the excitation regulation module 100. The excitation control module 100 calculates a current ratio of the output voltage of the pumped storage generator to the voltage of the power grid according to the digital voltage signal of the pumped storage generator and the digital voltage signal of the power grid.

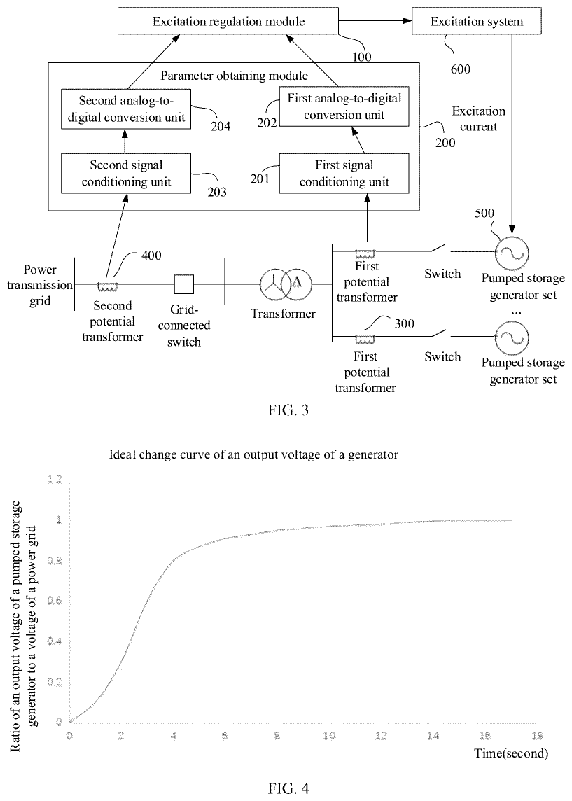

As shown in FIG. 3, a pumped storage generator set can be connected to a power transmission grid through a transformer and a grid-connected switch. The pumped storage generator set includes one or more pumped storage generators. When a pumped storage generator set includes a plurality of pumping storage generators 500, the first signal conditioning unit 201 is connected to the first potential transformer 300 of each of the pumped storage generators 500, so that the parameter obtaining module 200 obtains the voltage signal of each of the pumped storage generators 500.

In some embodiments, the first signal conditioning unit 201 is further configured to obtain a phase sequence and a phase of the pumped storage generator 500 according to the voltage signal sent by the first potential transformer 300, and send the phase sequence and the phase to the first analog-to-digital conversion unit 202. The second signal conditioning unit 203 is further configured to obtain a phase sequence and a phase of the power grid according to the voltage signal sent by the second potential transformer 400, and send the phase sequence and the phase to the second analog-to-digital conversion unit 204.

In some embodiments, the excitation regulation module 100 is specifically configured to:
obtain multiple power information of the pumped storage generator and the power grid sent by the first analog-to-digital conversion unit 202 and the second analog-to-digital conversion unit 204, respectively, the power information including a voltage, a phase sequence, and a phase;
determine, based on the power information, whether a grid connection condition is met at present; and
suspend the regulation of the control parameter of the excitation system when the grid connection condition is met and wait for the pumped storage generator to be connected to the power grid.

According to the technical solution provided in the embodiments of the present disclosure, after the parameter obtaining module obtains the voltage signal of the pumped storage generator and the voltage signal of the power grid through the first potential transformer and the second potential transformer, the excitation regulation module obtains a target control parameter regulation strategy for the excitation system according to the current ratio of the output voltage of the pumped storage generator to the voltage of the power grid, so as to achieve the control parameter regulation for the excitation system. In this way, different control parameter regulation strategies are provided for the excitation system at different operating stages before the pumped storage generator is connected to the power grid. The control parameter of the excitation system is dynamically regulated so as to provide control parameters matching different operating states of the excitation system, effectively avoiding excessive regulation and insufficient regulation, thereby optimizing the control effect of the excitation system.

### Embodiment 2

The excitation regulation module 100 of the apparatus for regulating a control parameter of an excitation system shown in FIG. 1 is specifically configured to determine a target ratio range in which the current ratio of the output voltage of the pumped storage generator 500 to the voltage of the power grid is located based on multiple preset adjacent ratio ranges and the current ratio of the output voltage of the pumping power storage generator 500 to the grid voltage; and
obtain a control parameter regulation strategy for the excitation system that matches the target ratio range as a target control parameter regulation strategy.

In some embodiments, the excitation regulation module 100 is specifically configured to perform at least one of the following steps:
when the target control parameter regulation strategy is a first parameter regulation strategy, regulating the control parameter of the excitation system based on the first parameter regulation strategy, so that a change rate of the control parameter increases with the increase of the output voltage of the pumped storage generator;
when the target control parameter regulation strategy is a second parameter regulation strategy, regulating the control parameter of the excitation system based on the second parameter regulation strategy, so that a change rate of the control parameter decreases with the increase of the output voltage of the pumped storage generator; or
when the target control parameter regulation strategy is a third parameter regulation strategy, maintaining the control parameter of the excitation system based on the third parameter regulation strategy.

The first parameter regulation strategy, the second parameter regulation strategy, and the third parameter regulation strategy correspond to a first ratio range, a second ratio range, and a third ratio range, respectively. The first ratio range, the second ratio range, and the third ratio range are adjacent ratio ranges, the maximum values of which increase in sequence. The ratio of the output voltage of the pumped storage generator 500 to the voltage of the power grid has different change trends in the first ratio range, the second ratio range, and the third ratio range.

In the whole operating process of the generator, the output voltage of the generator increases from 0 to close to or equal to the voltage of the power grid. It can also be understood as the ratio of the output voltage of the generator to the voltage of the power grid increasing from 0 to 1. It is not excluded that the ratio may decrease within a certain time period due to a specific factor.

In some embodiments, multiple adjacent ratio range sets should be within a range of 0 to 1, including 0 and 1.

The target control parameter regulation strategy is configured to regulate the current control parameter. The regulated control parameter can meet the voltage control requirement of the excitation system.

To better regulate the control parameter of the excitation system, an ideal change curve of the ratio of the output voltage of the generator to the voltage of the power grid can be pre-generated by a user according to actual requirements. In some embodiments, the change in the ratio of the output voltage of the generator to the voltage of the power grid can be categorized into a relatively large change rate, a relatively small change rate, or a change rate approximating zero based on time periods.

Further, by analyzing the ideal change curve of the ratio, the range of the ratio of the output voltage of the generator to the voltage of the power grid from 0 to 1 can be divided into multiple adjacent ratio ranges, for example, 0-0.8 is determined as a first ratio range, 0.8-0.99 is determined as a second ratio range, and 0.99-1 is determined as a third ratio range. In addition, the change trend of the ratio of the output voltage of the generator to the voltage of the power grid is different at different ratio ranges. Therefore, different control parameter regulation strategies need to be set for different ratio ranges. After the ratio range in which the current ratio of the output voltage of the generator to the voltage of the power grid is located is determined, the control parameter of the excitation system is regulated based on the control parameter regulation strategy that matches the determined ratio range, so that the excitation system can be controlled to regulate the output voltage of the generator as much as possible in accordance with the ideal voltage value, so that the change of the ratio of the output voltage of the generator to the voltage of the power grid can meet the ideal ratio change curve.

FIG. 4 is an optional graph showing the change in the ratio of the output voltage of the generator to the voltage of the power grid. As shown in FIG. 4, the ratio of the output voltage of the generator to the voltage of the power grid increases with time. When the ratio of the output voltage of the generator to the voltage of the power grid falls within the range of 0-0.8, the change rate of the ratio of the output voltage of the generator to the voltage of the power grid is relatively large, i.e., the voltage of the generator can be increased rapidly in this ratio range, so that the voltage of the generator can quickly approach a grid-connected voltage. When the ratio of the output voltage of the generator to the voltage of the power grid falls within the range of 0.8-0.99, the change rate of the ratio of the output voltage of the generator to the voltage of the power grid is relatively small, i.e., the voltage of the generator can be increased steadily within this ratio range, and the voltage increase per second is relatively small at this stage, avoiding excessive regulation. When the ratio of the output voltage of the generator to the voltage of the power grid falls within the range of 0.99-1, the ratio of the output voltage of the generator to the voltage of the power grid remains unchanged, i.e., the voltage of the generator remains unchanged within this range. The value of 0.99 in the foregoing example may be understood as a value approximated to 1, the specific value of which depends on an allowable error range of the grid-connected voltage.

In some embodiments, the excitation regulation module 100 is specifically configured to:
obtain, when the target control parameter regulation strategy is the first parameter regulation strategy, a current output voltage of the pumped storage generator sent by the first analog-to-digital conversion unit, a current voltage of the power grid sent by the second analog-to-digital conversion unit, and a preset first control parameter;
calculate a target regulation value Tᵢ for the control parameter of the excitation system according to a formula as follows:

$${T}_{i} = \frac{{k}_{1}}{{U}_{0} - U} {T}_{0} ,$$

where U is the current output voltage of the pumped storage generator, U₀ is the current voltage of the power grid, k₁ is a variable parameter, and T0 is a preset first control parameter, and
regulate the control parameter of the excitation system according to the target regulation value.

In some embodiments, the excitation control module 100 is specifically configured to:
obtain, when the target control parameter regulation strategy is the second parameter regulation strategy, a second control parameter corresponding to the case in which the ratio of the output voltage of the pumped storage generator to the voltage of the power grid is equal to a first ratio, the current output voltage of the pumped storage generator, and the current voltage of the power grid, the first ratio being the maximum value of the first ratio range;
calculate a target regulation value Tᵢ for the control parameter of the excitation system according to a formula as follows:

$${T}_{i} = \frac{{k}_{2} ( {U}_{0} - U )}{{U}_{0}} T ,$$

where T is the second control parameter corresponding to the case in which the ratio of the output voltage of the pumped storage generator to the voltage of the power grid is equal to the first ratio, and k2 is a variable parameter; and
regulate the control parameter of the excitation system according to the target regulation value.

In some embodiments, when the ratio of the output voltage of the pumped storage generator to the voltage of the power grid falls within the second ratio range, the target regulation value for the control parameter of the excitation system can also be calculated according to a formula as follows: Tᵢ=Tᵢ₋₁−a, where Tᵢ₋₁ is the previous target regulation value for the control parameter of the excitation system, and a is a constant greater than 0. By using this formula to calculate the target regulation value for the control parameter, it can also ensure that the control parameter decreases as the output voltage of the generator increases, thereby stabilizing the output voltage of the generator.

According to the technical solution provided in the embodiments of the present disclosure, a first ratio range, a second ratio range, and a third ratio range are determined by analyzing the change rate of the change curve of the target ratio, so that three adjacent ratio ranges are set, thereby providing control parameters match the three adjacent ratio ranges for the excitation system in different operating states, effectively avoiding excessive regulation and insufficient regulation of the excitation system, and optimizing the control effect of the excitation system.

### Embodiment 3

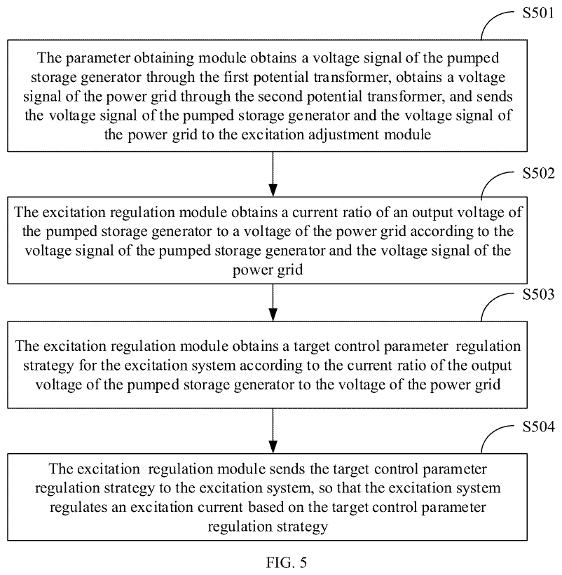

FIG. 5 is a flowchart of a method for regulating a control parameter of an excitation system according to Embodiment 3 of the present disclosure. The method can be performed by a device for regulating a control parameter of an excitation system in any embodiment of the present disclosure. The device for regulating a control parameter of an excitation system can be implemented in a form of hardware and/or software, and is configured in the apparatus for regulating a control parameter of an excitation system in any embodiment of the present disclosure. As shown in FIG. 5, the method includes the following steps.

In step S501, the parameter obtaining module obtains a voltage signal of the pumped storage generator through the first potential transformer, obtains a voltage signal of the power grid through the second potential transformer, and sends the voltage signal of the pumped storage generator and the voltage signal of the power grid to the excitation regulation module.

In step S502, the excitation regulation module obtains a current ratio of an output voltage of the pumped storage generator to a voltage of the power grid according to the voltage signal of the pumped storage generator and the voltage signal of the power grid.

In step S503, the excitation regulation module obtains a target control parameter regulation strategy for the excitation system according to the current ratio of the output voltage of the pumped storage generator to the voltage of the power grid.

In step S504, the excitation regulation module sends the target control parameter regulation strategy to the excitation system, so that the excitation system regulates an excitation current based on the target control parameter regulation strategy.

According to the technical solution provided in the embodiments of the present disclosure, after the parameter obtaining module obtains the voltage signal of the pumped storage generator and the voltage signal of the power grid through the first potential transformer and the second potential transformer, the excitation regulation module obtains the target control parameter regulation strategy for the excitation system according to the current ratio of the output voltage of the pumped energy storage generator to the voltage of the power grid, so as to achieve the control parameter regulation for the excitation system. In this way, different control parameter regulation strategies are provided for the excitation system at different operating stages before the pumped storage generator is connected to the power grid. The control parameter of the excitation system is dynamically regulated so as to provide control parameters matching different operating states of the excitation system, effectively avoiding excessive regulation and insufficient regulation, thereby optimizing the control effect of the excitation system.

### Embodiment 4

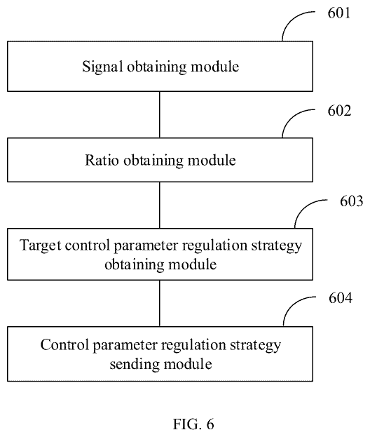

FIG. 6 is a block diagram of a structure of a device for regulating a control parameter of an excitation system according to Embodiment 4 of the present disclosure. The device for regulating a control parameter of an excitation system specifically includes a signal obtaining module 601, a ratio obtaining module 602, a target control parameter regulation strategy obtaining module 603, and a control parameter regulation strategy sending module 604.

The signal obtaining module 601 is configured in the parameter obtaining module and is configured to obtain a voltage signal of the pumped storage generator through the first potential transformer, obtain a voltage signal of the power grid through the second potential transformer, and send the voltage signal of the pumped storage generator and the voltage signal of the power grid to the excitation regulation module.

The ratio obtaining module 602 is configured in the excitation regulation module and is configured to obtain a current ratio of an output voltage of the pumped storage generator to a voltage of the power grid according to the voltage signal of the pumped storage generator and the voltage signal of the power grid.

The target control parameter regulation strategy obtaining module 603 is configured in the excitation control module and is configured to obtain a target control parameter regulation strategy for the excitation system according to the current ratio of the output voltage of the pumped storage generator to the voltage of the power grid.

The control parameter regulation strategy sending module 604 is configured in the excitation regulation module and is configured to send the target control parameter regulation strategy to the excitation system, so that the excitation system regulates the excitation current based on the target control parameter regulation strategy.

According to the technical solution provided in the embodiments of the present disclosure, after the parameter obtaining module obtains the voltage signal of the pumped storage generator and the voltage signal of the power grid through the first potential transformer and the second potential transformer, the excitation regulation module obtains a target control parameter regulation strategy for the excitation system according to the current ratio of the output voltage of the pumped storage generator to the voltage of the power grid, so as to achieve the control parameter regulation for the excitation system. In this way, different control parameter regulation strategies are provided for the excitation system at different operating stages before the pumped storage generator is connected to the power grid. The control parameter of the excitation system is dynamically regulated so as to provide control parameters matching different operating states of the excitation system, effectively avoiding excessive regulation and insufficient regulation, thereby optimizing the control effect of the excitation system.

The device for regulating a control parameter of an excitation system provided in the embodiments of the present disclosure can perform the method for regulating a control parameter of an excitation system provided in any embodiment of the present disclosure, and is provided with corresponding function modules and beneficial effects for performing the method.

In some embodiments, the method for regulating a control parameter of an excitation system may be implemented as a computer program, which is physically contained in a computer-readable storage medium, such as a storage unit. In some embodiments, part or all of the computer program may be loaded and/or installed in a heterogeneous hardware accelerator through a ROM and/or a communication unit. When the computer program is loaded in the RAM and executed by a processor, one or more steps of the foregoing method for regulating a control parameter of an excitation system can be performed. Alternatively, in other embodiments, a processor may be configured to execute the method for regulating a control parameter of an excitation system in any other suitable manner (e.g., by means of firmware).

Various implementations of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or a combination thereof. The various implementations may include being implemented in one or more computer programs that can be executed and/or interpreted in a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

The computer program for implementing the method of the present disclosure may be written in any combination of one or more programming languages. The computer program may be provided to a processor of a general-purpose computer, a dedicated computer, or other programmable data processing apparatus, so that when the computer program is executed by the processor, the functions/operations specified in the flowchart and/or the block diagram are implemented. The computer program may be executed entirely on a machine or partially on a machine, or it may be executed as a stand-alone software package partially on a machine and partially on a remote machine, or entirely on a remote machine or server.

In the context of the present disclosure, the computer-readable storage medium may be a physical medium capable of containing or storing computer programs that can be used by, or in conjunction with, an instruction execution system, apparatus, or device. The computer-readable storage medium may include, but is not limited to, an electronic, magnetic, optical, electromagnetic, infrared, or semiconductor system, apparatus, or device, or any suitable combination thereof. Alternatively, the computer-readable storage medium may be a machine-readable signal medium. In a more specific example, the machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

To provide interaction with users, the systems and technologies described herein may be implemented in a heterogeneous hardware accelerator, which is provided with a display device (such as a CRT (cathode ray tube) or LCD (liquid crystal display) monitor) for displaying information to users, a keyboard, and a pointing device (such as a mouse or a trackball). Users can provide input to the heterogeneous hardware accelerator through the keyboard and the pointing device. Other types of devices may also be configured to provide interaction with users. For example, a feedback received by users may be any form of sensing feedback (such as a visual feedback, auditory feedback, or tactile feedback). In addition, user input may be received in any form (including sound input, voice input, or tactile input).

The systems and technologies described herein may be implemented in a computing system (such as a data server) that includes a backend component, or a computing system (such as an application server) that includes a middleware component, or a computing system (such as a user computer that includes a graphical user interface or a web browser through which a user may interact with the systems and technologies described herein) that includes a frontend component, or any combination of the backend component, the middleware component, and the frontend component. Components of the system may be interconnected by a digital data communication in any form or medium (e.g., a communication network). For example, the communication network may be a local area network (LAN), a wide area network (WAN), a block chain network, or the Internet.

The computing system may include a client and a server. The client and the server are generally far away from each other and typically interact through a communication network. A client-server relationship is generated by computer programs that run on corresponding computers and have a client-server relationship with each other. The server may be a cloud server, also known as a cloud computing server or a cloud host, which is a host product in a cloud computing service system, solving the problems of difficult management and weak business scalability in traditional physical hosts and Virtual Private Server (VPS) services.

It should be understood that various forms of the above processes can be used, with steps reordered, added or deleted. For example, the steps described in the present disclosure may be performed simultaneously, sequentially, or in different orders. Provided that the expected result of the technical solution of the present disclosure can be achieved, the order of the steps is not limited herein.

The above specific embodiments do not constitute a limitation on the protection scope of the present disclosure. A person skilled in the art should understand that various modifications, combinations, sub-combinations, and replacements can be made according to design requirements and other factors. Any modification, equivalent replacement and improvement made within the spirit and principles of the present disclosure all fall within the protection scope of the present disclosure.

1. An apparatus for regulating a control parameter of an excitation system, comprising;
a parameter obtaining module and an excitation regulation module,
wherein the parameter obtaining module is connected to a first potential transformer and a second potential transformer, and the parameter obtaining module is configured to obtain a voltage signal of a pumped storage generator through the first potential transformer, obtain a voltage signal of a power grid through the second potential transformer, and send the voltage signal of the pumped storage generator and the voltage signal of the power grid to the excitation regulation module; and
the excitation regulation module is connected to an excitation system and the parameter obtaining module, and the excitation regulation module is configured to obtain a current ratio of an output voltage of the pumped storage generator to a voltage of the power grid according to the voltage signal of the pumped storage generator and the voltage signal of the power grid, obtain a target control parameter regulation strategy for the excitation system according to the current ratio of the output voltage of the pumped storage generator to the voltage of the power grid, and send the target control parameter regulation strategy to the excitation system, so that the excitation system regulates an excitation current based on the target control parameter regulation strategy.

2. The apparatus according to claim 1, wherein the parameter obtaining module includes a first signal conditioning unit, a second signal conditioning unit, a first analog-to-digital conversion unit, and a second analog-to-digital conversion unit;
wherein the first signal conditioning unit is connected to the first potential transformer and is configured to remove noise from an analog voltage signal of the pumped storage generator;
the second signal conditioning unit is connected to the second potential transformer and is configured to remove noise from an analog voltage signal of the power grid;
the first analog-to-digital conversion unit is connected to the first signal conditioning unit and is configured to convert the analog voltage signal of the pumped storage generator into a digital voltage signal;
the second analog-to-digital conversion unit is connected to the second signal conditioning unit and is configured to convert the analog voltage signal of the power grid into a digital voltage signal; and
the excitation regulation module is connected to the first analog-to-digital conversion unit and the second analog-to-digital conversion unit, and the excitation regulation module is configured to obtain the current ratio of the output voltage of the pumped storage generator to the voltage of the power grid according to the digital voltage signal of the pumped storage generator and the digital voltage signal of the power grid.

3. The apparatus according to claim 2, wherein the excitation regulation module is configured to:
determine a target ratio range in which the current ratio of the output voltage of the pumped storage generator to the voltage of the power grid is located according to multiple preset adjacent ratio ranges and the current ratio of the output voltage of the pumped storage generator to the voltage of the power grid; and
obtain a control parameter regulation strategy for the excitation system that matches the target ratio range as the target control parameter regulation strategy.

4. The apparatus according to claim 3, wherein the excitation regulation module is configured to perform at least one of the following steps:
regulating, when the target control parameter regulation strategy is a first parameter regulation strategy, the control parameter of the excitation system based on the first parameter regulation strategy, so that a change rate of the control parameter increases with an increase of the output voltage of the pumped storage generator;
regulating, when the target control parameter regulation strategy is a second parameter regulation strategy, the control parameter of the excitation system based on the second parameter regulation strategy, so that a change rate of the control parameter decreases with an increase of the output voltage of the pumped storage generator; and
maintaining, when the target control parameter regulation strategy is a third parameter regulation strategy, the control parameter of the excitation system based on the third parameter regulation strategy to keep the control parameter stable;
the first parameter regulation strategy, the second parameter regulation strategy, and the third parameter regulation strategy corresponding to a first ratio range, a second ratio range, and a third ratio range, respectively, wherein the first ratio range, the second ratio range, and the third ratio range are adjacent ratio ranges, the maximum values of which increase in sequence, and a change trend of the ratio of the output voltage of the pumped storage generator to the voltage of the power grid is different in the first ratio range, the second ratio range, and the third ratio range.

5. The apparatus according to claim 4, wherein the excitation regulation module is configured to:
obtain, when the target control parameter regulation strategy is the first parameter regulation strategy, a current output voltage of the pumped storage generator sent by the first analog-to-digital conversion unit, a current voltage of the power grid sent by the second analog-to-digital conversion unit, and a preset first control parameter;
calculate a target regulation value Tᵢ for the control parameter of the excitation system according to a formula as follows, and regulate the control parameter of the excitation system according to the target regulation value:
$${T}_{i} = \frac{{k}_{1}}{{U}_{0} - U} {T}_{0}$$
where U is the current output voltage of the pumped storage generator, U₀ is the current voltage of the power grid, k₁ is a variable parameter, and T₀ is the preset first control parameter.

6. The apparatus according to claim 4, wherein the excitation regulation module is configured to:
obtain, when the target control parameter regulation strategy is the second parameter regulation strategy, a second control parameter corresponding to a case in which the ratio of the output voltage of the pumped storage generator to the voltage of the power grid is equal to a first ratio, a current output voltage of the pumped storage generator, and a current voltage of the power grid;
the first ratio being the maximum value of the first ratio range;
calculate a target regulation value Tᵢ for the control parameter of the excitation according to a formula as follows and regulate the control parameter of the excitation according to the target regulation value:
$${T}_{i} = \frac{{k}_{2} ( {U}_{0} - U )}{{U}_{0}} T$$
where T is the second control parameter when the ratio of the output voltage of the pumped storage generator to the voltage of the power grid is equal to the first ratio, U is the current output voltage of the pumped storage generator, U₀ is the current voltage of the power grid, and k₂ is a variable parameter.

7. The apparatus according to claim 4, wherein the excitation regulation module is configured to:
obtain multiple pieces of power information of the pumped storage generator and the power grid sent by the first analog-to-digital conversion unit and the second analog-to-digital conversion unit, respectively, and determine, based on the power information, whether a grid connection condition is met at present;
the power information comprising a voltage, a phase sequence, and a phase; and
suspend a regulation of the control parameter of the excitation system when the grid connection condition is met, and wait for the pumped storage generator to be connected to the power grid.

8. A method for regulating a control parameter of an excitation system, applied to the apparatus according to claim 1, the method comprising:
the parameter obtaining module obtaining a voltage signal of a pumped storage generator through the first potential transformer, obtaining a voltage signal of a power grid through the second potential transformer, and sending the voltage signal of the pumped storage generator and the voltage signal of the power grid to the excitation regulation module;
the excitation regulation module obtaining a current ratio of an output voltage of the pumped storage generator to a voltage of the power grid according to the voltage signal of the pumped storage generator and the voltage signal of the power grid;
the excitation regulation module obtaining a target control parameter regulation strategy for the excitation according to the current ratio of the output voltage of the pumped storage generator to the voltage of the power grid; and
the excitation regulation module sending the target control parameter regulation strategy to the excitation system, so that the excitation system regulates an excitation current based on the target control parameter regulation strategy.

9. A device for regulating a control parameter of an excitation system, applied to the apparatus according to claim 1, the device comprising:
a signal obtaining module configured in the parameter obtaining module and configured to obtain a voltage signal of a pumped storage generator through the first potential transformer, obtain a voltage signal of a power grid through the second potential transformer, and send the voltage signal of the pumped storage generator and the voltage signal of the power grid to the excitation regulation module;
a ratio obtaining module configured in the excitation regulation module and configured to obtain a current ratio of an output voltage of the pumped storage generator to a voltage of the power grid according to the voltage signal of the pumped storage generator and the voltage signal of the power grid;
a target control parameter regulation strategy obtaining module configured in the excitation regulation module and configured to obtain a target control parameter regulation strategy for the excitation according to the current ratio of the output voltage of the pumped storage generator to the voltage of the power grid; and
a control parameter regulation strategy sending module configured in the excitation regulation module and configured to send the target control parameter regulation strategy to the excitation system, so that the excitation system regulates an excitation current based on the target control parameter regulation strategy.

10. A non-transitory computer-readable storage medium having computer instructions stored therein, the computer instructions, when executed by a processor, cause the processor to perform the method for regulating a control parameter of an excitation according to claim 8.

11. The apparatus according to claim 4, wherein when the ratio of the output voltage of the pumped storage generator to the voltage of the power grid falls within the second ratio range, a target regulation value for the control parameter of the excitation system is calculated according to a formula as follows: Tᵢ=Tⱼ₋₁−a, where Tᵢ₋₁ is a previous target regulation value for the control parameter of the excitation system, and a is a constant greater than 0.

12. The method according to claim 8, wherein the parameter obtaining module includes a first signal conditioning unit, a second signal conditioning unit, a first analog-to-digital conversion unit, and a second analog-to-digital conversion unit, the method further comprising:
removing, by the first signal conditioning unit, noise from an analog voltage signal of the pumped storage generator;
removing, by the second signal conditioning unit, noise from an analog voltage signal of the power grid;
convening, by the first analog-to-digital conversion unit, the analog voltage signal of the pumped storage generator into a digital voltage signal;
converting, by the second analog-to-digital conversion unit, the analog voltage signal of the power grid into a digital voltage signal; and
obtaining, by the excitation regulation module, the current ratio of the output voltage of the pumped storage generator to the voltage of the power grid according to the digital voltage signal of the pumped storage generator and the digital voltage signal of the power grid.

13. The method according to claim 12, further comprising:
determining, by the excitation regulation module, a target ratio range in which the current ratio of the output voltage of the pumped storage generator to the voltage of the power grid is located according to multiple preset adjacent ratio ranges and the current ratio of the output voltage of the pumped storage generator to the voltage of the power grid; and
obtaining, by the excitation regulation module, a control parameter regulation strategy for the excitation system that matches the target ratio range as the target control parameter regulation strategy.

14. The method according to claim 13, further comprising:
regulating, by the excitation regulation module, the control parameter of the excitation system based on a first parameter regulation strategy when the target control parameter regulation strategy is the first parameter regulation strategy, so that a change rate of the control parameter increases with an increase of the output voltage of the pumped storage generator;
regulating, by the excitation regulation module, the control parameter of the excitation system based on a second parameter regulation strategy when the target control parameter regulation strategy is the second parameter regulation strategy, so that a change rate of the control parameter decreases with an increase of the output voltage of the pumped storage generator; and
maintaining, by the excitation regulation module, the control parameter of the excitation system based on the third parameter regulation strategy to keep the control parameter stable when the target control parameter regulation strategy is a third parameter regulation strategy;
the first parameter regulation strategy, the second parameter regulation strategy, and the third parameter regulation strategy corresponding to a first ratio range, a second ratio range, and a third ratio range, respectively, wherein the first ratio range, the second ratio range, and the third ratio range are adjacent ratio ranges, the maximum values of which increase in sequence, and a change trend of the ratio of the output voltage of the pumped storage generator to the voltage of the power grid is different in the first ratio range, the second ratio range, and the third ratio range.

15. The method according to claim 14, further comprising:
obtaining, when the target control parameter regulation strategy is the first parameter regulation strategy, a current output voltage of the pumped storage generator sent by the first analog-to-digital conversion unit, a current voltage of the power grid sent by the second analog-to-digital conversion unit, and a preset first control parameter;
calculating a target regulation value Tᵢ for the control parameter of the excitation according to a formula as follows, and regulating the control parameter of the excitation according to the target regulation value:
$${T}_{i} = \frac{{k}_{1}}{{U}_{0} - U} {T}_{0}$$
where U is the current output voltage of the pumped storage generator, U is the current voltage of the power grid, k₁ is a variable parameter, and T₀ is the preset first control parameter.

16. The method according to claim 13, further comprising:
obtaining, when the target control parameter regulation strategy is the second parameter regulation strategy, a second control parameter corresponding to a case in which the ratio of the output voltage of the pumped storage generator to the voltage of the power grid is equal to a first ratio, a current output voltage of the pumped storage generator, and a current voltage of the power grid;
the first ratio being the maximum value of the first ratio range;
calculating a target regulation value Tᵢ for the control parameter of the excitation according to a formula as follows and regulating the control parameter of the excitation according to the target regulation value:
$${T}_{i} = \frac{{k}_{2} ( {U}_{0} - U )}{{U}_{0}} T$$
wherein T is the second control parameter when the ratio of the output voltage of the pumped storage generator to the voltage of the power grid is equal to the first ratio, U is the current output voltage of the pumped storage generator, U₀ is the current voltage of the power grid, and k₂ is a variable parameter.

17. The method according to claim 14, further comprising:
obtaining, by the excitation regulation module, multiple pieces of power information of the pumped storage generator and the power grid sent by the first analog-to-digital conversion unit and the second analog-to-digital conversion unit, respectively, and determining, based on the power information, whether a grid connection condition is met at present;
the power information including a voltage, a phase sequence, and a phase; and
suspending, by the excitation regulation module, a regulation of the control parameter of the excitation system when the grid connection condition is met, and waiting for the pumped storage generator to be connected to the power grid.

18. The method according to claim 14, further comprising:
calculating, when the ratio of the output voltage of the pumped storage generator to the voltage of the power grid falls within the second ratio range, a target regulation value for the control parameter of the excitation according to a formula as follows: Tᵢ=Tᵢ₋₁−a, where Tᵢ₋₁ is a previous target regulation value for the control parameter of the excitation system, and a is a constant greater than 0.
